(19) United States
(12) Patent Application Publication
(10) Pub. No.: US 2023/0066295 A1
(43) Pub. Date: Mar. 2, 2023

(54) CONFIGURING AN ASSOCIATION BETWEEN OBJECTS BASED ON AN IDENTIFICATION OF A STYLE ASSOCIATED WITH THE OBJECTS

(71) Applicant: Capital One Services, LLC, McLean, VA (US)

(72) Inventors: Lin Ni Lisa CHENG, New York, NY (US); Vyjayanthi VADREVU, Pflugerville, TX (US); Xiaoguang ZHU, New York, NY (US)

(21) Appl. No.: 17/445,897

(22) Filed: Aug. 25, 2021

(51) Int. Cl. G06Q 30/06; H04L 29/08; G06K 9/62; G06N 3/02

(52) U.S. Cl. CPC G06Q 30/0627; H04L 67/22; G06K 9/627; G06N 3/02

(57) ABSTRACT

In some implementations, a system may receive engagement data associated with a user. The system may determine, using a style classification model, that the engagement data is associated with the style, wherein the style classification model is trained to identify styles of a subject based on reference images associated with one or more of the styles of the subject. The system may determine, based on the engagement data, a level of interest that the user has in one or more objects associated the style. The system may identify, based on the level of interest satisfying a threshold, a first object and a second object that are associated with the style. The system may configure an association between the first object and the second object. The system may provide the association to permit the user to interact with the first object, the second object, and/or the association.

### BACKGROUND

Various platforms enable a user to access and/or identify, via user device, objects or items that may be of interest to the user. For example, the user (e.g., a consumer) may utilize a web browser, web pages of merchants, social media, and/or applications on the user device to browse information on the objects, images depicting the objects, audio media associated with the objects, and/or video media associated with the objects, and so on. Accordingly, the user may identify a particular characteristic of the object, such as a size of the object, a shape of the object, a type of the object, a color of the object, a producer or manufacturer of the object, a cost of the object, a location of the object, and/or a style of the object, among other types of characteristics.

### SUMMARY

Some implementations described herein relate to a system for configuring an association between objects. The system may include one or more memories and one or more processors communicatively coupled to the one or more memories. The one or more processors may be configured to receive engagement data associated with a user. The one or more processors may be configured to determine, based on the one or more images and using a style classification model, that a first object, associated with the object type, is associated with a style of a subject. The one or more processors may be configured to analyze, based on the object type, inventory data that is associated with the style. The one or more processors may be configured to identify, from the inventory data, a second object that is associated with the first object. The one or more processors may be configured to configure the association between the first object and the second object. The one or more processors may be configured to provide, within a notification to the user, the association to permit the user to engage in an action involving the first object, the second object, or the association.

Some implementations described herein relate to a non-transitory computer-readable medium that stores a set of instructions for a system. The set of instructions, when executed by one or more processors of the system, may cause the system to receive one or more images associated with user activity involving an object type. The set of instructions, when executed by one or more processors of the system, may cause the system to determine, based on the user activity, a level of interest that the user has in the object type. The set of instructions, when executed by one or more processors of the system, may cause the system to determine, using a style classification model and based on determining that the level of interest that satisfies a threshold, that a first object, associated with the object type, is associated with a style. The set of instructions, when executed by one or more processors of the system, may cause the system to identify, from inventory data in an inventory data structure associated with the style, a second object that is related to the first object. The set of instructions, when executed by one or more processors of the system, may cause the system to configure, based on a relationship between the first object and the second object, a layout of the first object and the second object. The set of instructions, when executed by one or more processors of the system, may cause the system to provide, via a user interface, the layout to facilitate an interaction that involves at least one of the first object or the second object.

Some implementations described herein relate to a method associated with configuring an association between objects. The method may include receiving, by a device, engagement data associated with a user, where the engagement data is associated with user activity involving the user accessing one or more images associated with a style. The method may include determining, by the device and using a style classification model, that the engagement data is associated with the style, where the style classification model is trained to identify styles of a subject based on reference images associated with one or more of the styles of the subject. The method may include determining, by the device and based on the engagement data, a level of interest that the user has in one or more objects associated the style. The method may include identifying, by the device and based on the level of interest satisfying a threshold, a first object and a second object that are associated with the style. The method may include configuring, by the device, the association between the first object and the second object. The method may include providing, by the device, the association to permit the user to interact with at least one of the first object, the second object, or the association.

### BRIEF DESCRIPTION OF THE DRAWINGS

FIGS. 1A-1C are diagrams of an example implementation associated with configuring an association between objects based on an identification of a style associated with the objects, as described herein.

FIG. 2 is a diagram of an example environment in which systems and/or methods described herein may be implemented.

FIG. 3 is a diagram of example components of one or more devices of FIG. 2.

FIG. 4 is a flowchart of an example process relating to configuring an association between objects based on an identification of a style associated with the objects.

### DETAILED DESCRIPTION

The following detailed description of example implementations refers to the accompanying drawings. The same reference numbers in different drawings may identify the same or similar elements.

An application associated with a service provider may be offered and/or provided to a user in a manner that increases the user's engagement with the application and/or a service of the service provider. For example, a system associated with the application and/or service provider may monitor and/or track user activity involving the application to permit the system to learn or identify certain interests of a user that is utilizing the application. Using the learned interests, the system can offer and/or provide information associated with objects (e.g., products, artifacts, or other items) that are most likely of interest to the user.

The system may learn and/or identify certain interests from information that is explicitly accessible to the application and/or through the application. The information may be described in text, images, audio, video, or other types of media that are provided via an interface of the application, via a web page accessed via the application, a link accessed via the application, a social media post accessed via the application, an online shopping or transaction page accessed via the application, and so on. In some cases, the system may learn and/or identify certain interests from metadata obtained by the application (e.g., metadata associated with objects that is provided and/or accessible to the application based on the application accessing or providing the information). The metadata may include or identify (e.g., via tags or annotations) certain keywords, classifications, associations, and/or other types of descriptors of the objects.

However, certain interests or classifications associated with an object may not be readily identifiable and/or indicated via the explicitly accessible information or the metadata associated with the information. For example, a style of an object (or other classification of the object) may not be described within the information and/or indicated in metadata associated with an object. More specifically, a style of home decor in a room that is depicted in an image may not be described in information associated with the image or indicated in metadata associated with the image. Accordingly, the system described above may be unable to identify that a user accessing, via the application, such an image (or multiple images depicting the same style) has an interest in the style and/or that objects depicted in the image are associated with that style.

Some implementations described herein provide an object analysis system that enables a configuration of an association between objects based on an identification of a particular classification of the objects, such as a style of the objects. The object analysis system, as described herein, may analyze one or images that are accessed during a user session of a user. The user session may be associated with user activity of an application that is performed by the user during the user session. For example, the object analysis system may include and/or utilize an object classification model that is trained and/or configured to determine a style of a particular object that is depicted in the one or more images. The object analysis system may, based on identifying the style of an object, identify another object that has the same style, and configure an association between the objects and provide (e.g., via a notification) and/or indicate (e.g., via an interface of an application and/or a user device) the association to the user. The association may be provided in association with the user activity session and/or another user session involving the application.

In this way, the object analysis system is capable of detecting and/or identifying an interest of a user and/or an association between objects without the interest and/or the association being identified information associated with the objects and/or metadata associated with the objects. Accordingly, the object analysis system may accurately determine an interest of a user and/or accurately configure an association between objects, thereby avoiding wasting resources that would otherwise be consumed using a system that is not configured and/or does not perform one or more processes described herein. For example, a system that provides or offers, to a user, an object (or information on an object) that is not associated with a style of interest to the user (e.g., because the style is not indicated in information or metadata associated with the object) would waste computing resources (e.g., processor resources and/or memory resources) and/or communication resources providing or offering the object to the user because the user is not likely to be interested in the object. Similarly, a system that configures an association between objects with different styles or other classifications (e.g., because the styles or other classifications are not indicated in information or metadata associated with the objects), and provides or offers the association to a user would waste computing resources and/or communication resources providing or offering the association because the user is not likely to be interested in the association (e.g., because the styles of the objects are different) because the styles may not be compatible and/or the association may not have a use (e.g., because certain classifications of the objects are not compatible).

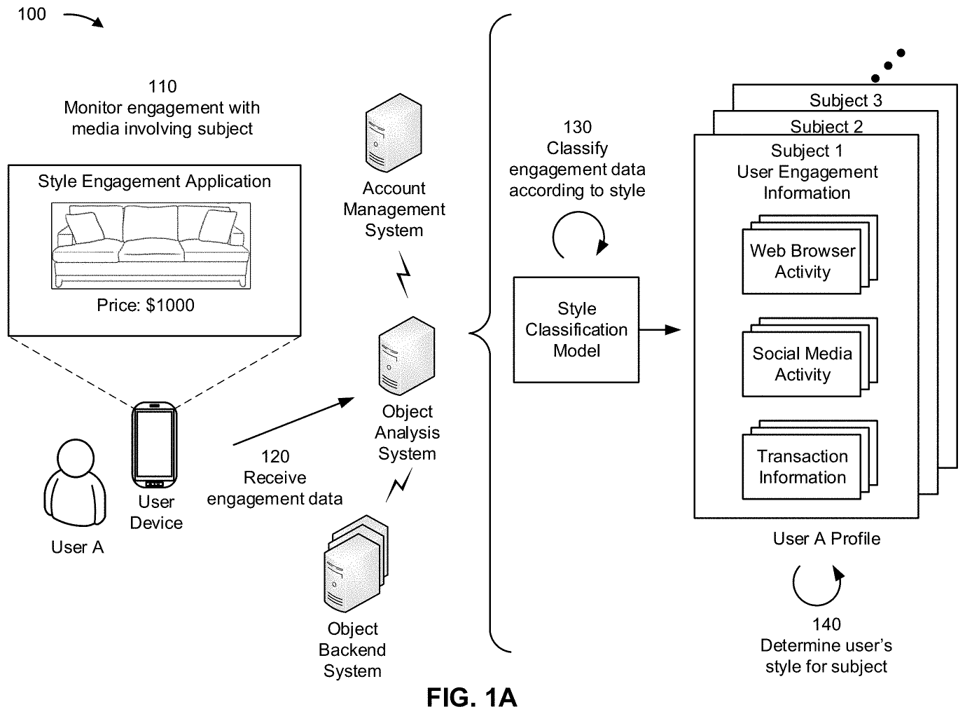

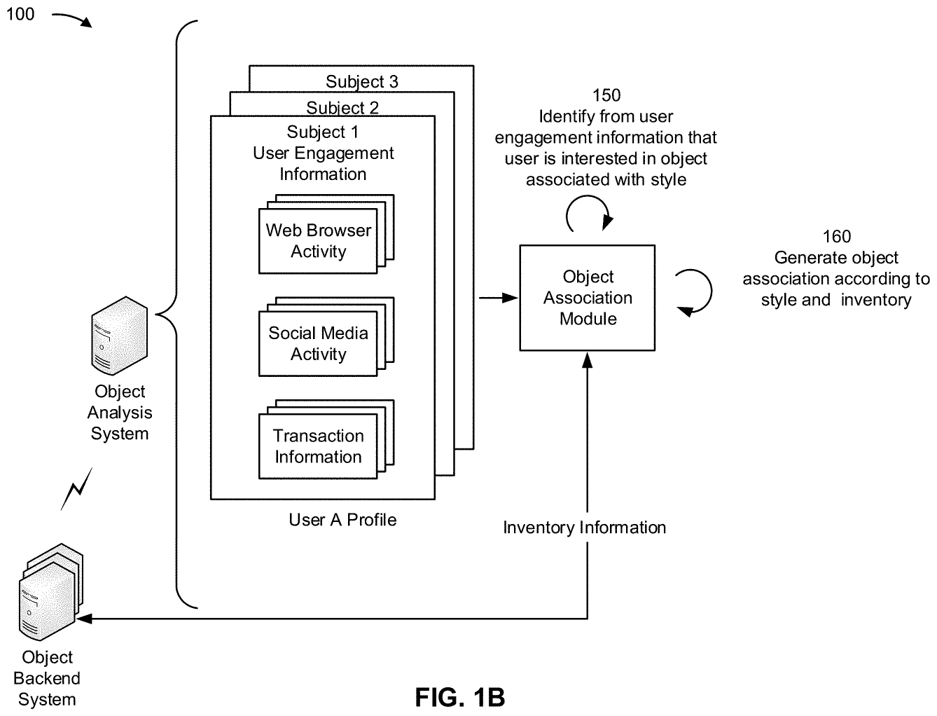

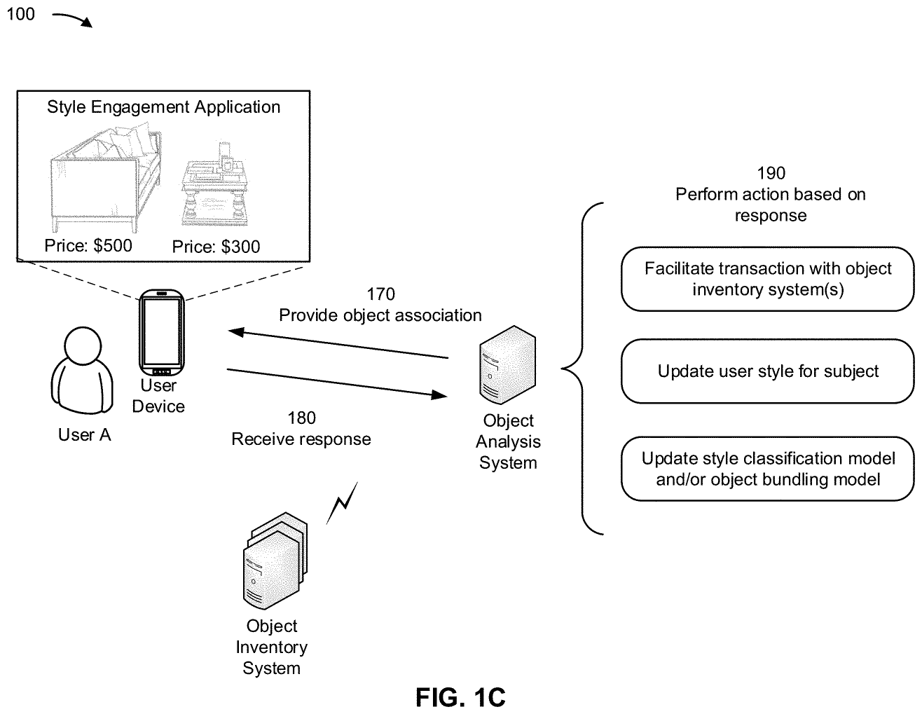

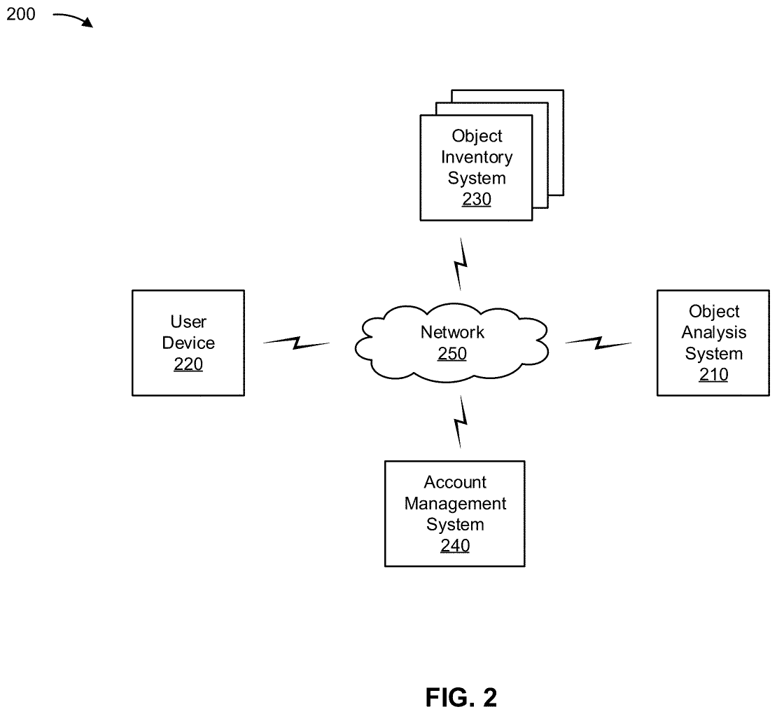

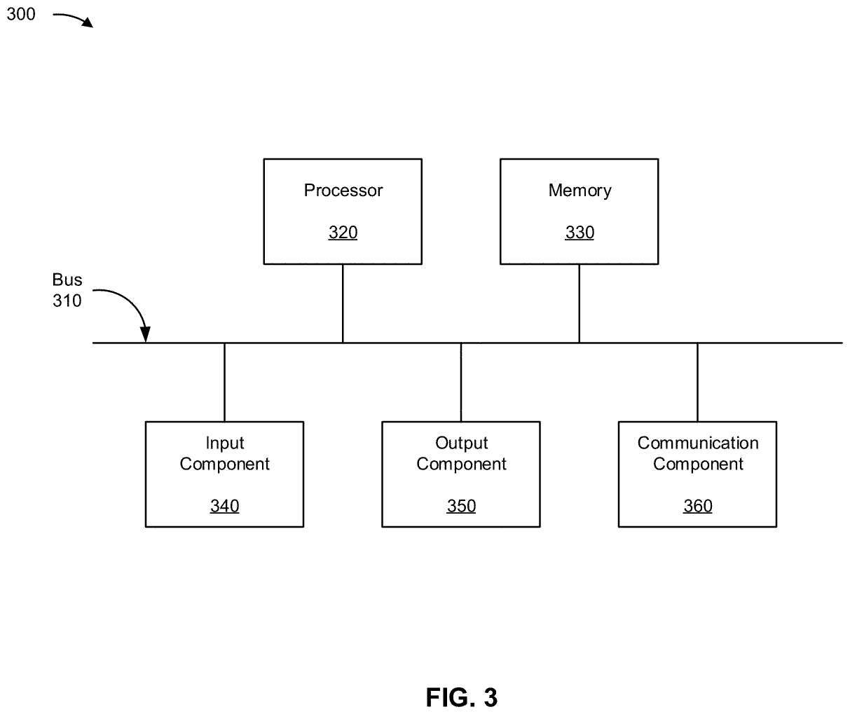

FIGS. 1A-1C are diagrams of an example implementation 100 associated with configuring an association between objects based on an identification of a style associated with the objects. As shown in FIGS. 1A-1C, example implementation 100 includes an object analysis system, an account management system, an object backend system, and a user device associated with a user (User A). These devices are described further below, at least in connection with FIG. 2 and FIG. 3.

As shown in FIG. 1A, and by reference number 110, an application of the user device monitors engagement with media involving a subject. The engagement with media may involve user activity during a session of an application that facilitates access to media associated with one or more objects. More specifically, the user activity may involve the user accessing web pages, social media posts, and/or application interfaces that include one or more images, audio, and/or video associated with objects. The objects may include any types of items that may include or be representative of products, digital media, pieces of art, locations, and/or buildings, among other examples. As more specific examples, an object may include a shirt that is for sale, an object may be a piece of furniture or decoration for a room, an object may be an image or description of a travel destination, an object may be a vehicle used in a form of transportation or travel, an object may be a painting, and so on.

In example implementation 100, an application (“Style Engagement Application”) may be installed on the user device that includes a web browser monitor, a social monitor, a transaction monitor, or other type of monitor to monitor user activity by the user. As described herein, the object analysis system (e.g., via the user device and/or the application) may monitor user activity by the user. The user activity may include online activity (e.g., web browsing associated with objects and/or searching for objects), a social media activity (e.g., browsing social media posts, engaging with social media posts through comments or interactions., such as indications of likes, dislikes, or other types of emotional responses), or a transaction-based activity (e.g., an online shopping activity that involves a purchase or a return of an object, such as a product).

The application on the user device may be associated with the object analysis system. For example, the object analysis system may serve as a backend system of the application that is configured to process information and/or engagement data associated with the application in association with one or more implementations described herein. In some implementations, to permit the object analysis system to perform one or more operations described herein (e.g., monitor user activity and/or provide an association of objects), the object analysis system may receive express authorization from the user via the application. For example, the object analysis system may request the user to authorize monitoring of the user activity, receive a user input that authorizes the monitoring of the user activity, and capture, based on receiving the user input, engagement data from the user activity.

The object analysis system may receive, from the user (e.g., via the user device), access information that permits the object analysis system to operate in accordance with examples described herein. For example, the access information may include a set of credentials associated with an account of the user (e.g., a user account that is managed and/or maintained by the account management system). The account may include a membership account associated with the application, a transaction account (e.g., a financial account, such as a bank account, a credit account, and/or a debit account), and/or a messaging account (e.g., an email account). The set of credentials may include a username/password combination for the user and the account, a security token (e.g., that provides limited access to the account) associated with the user and the account, and/or a biometric associated with the user.

As described herein, a transaction account may be associated with (e.g., registered to and/or available to) a user to permit the user to engage in transactions via the transaction account (e.g., using funds associated with the transaction account). The transaction account may be managed and/or maintained for the user by the account management system (e.g., using a transaction log to permit the user to view and/or access transaction activity of the transaction account). In some implementations, the account management system may manage hundreds, thousands, or more transaction accounts, each of which may be used in hundreds, thousands, or more transactions, and/or the like. Accordingly, the account management system may have access to object information associated with the accounts managed by the account management system.

In some implementations, the object analysis system may receive the access information based on requesting the access information from the user device (e.g., by providing a prompt via a display associated with the user device) and/or based on a user of the user device inputting the access information (e.g., via a user interface, via an application installed on the user device, and/or the like). According to some implementations, the object analysis system may perform a verification process the to verify that a user that provided the input is an authorized user of the user device and/or an authorized user associated with an account described herein. Such a verification process may include requesting and processing credentials (e.g., a username, password, personal identification number, and/or the like), associated with an authorized user, personal information associated with an authorized user, security information associated with an authorized user, a biometric associated with an authorized user, and/or the like to authenticate the user. In some implementations, the object analysis system may utilize a two-factor authentication process to receive authorization information from the user. The two-factor authentication process may increase a security of providing the object analysis system with access to the component of the user device by providing the object analysis system with limited access to the component, by providing the user of the user device with control over whether the object analysis system can access the component, and/or the like.

To maintain privacy of a user associated with a user account, the object analysis system may ensure that the user opts in to one or more services associated a service provider of the object analysis system (e.g., via the access information) to enable monitoring of the user activity. Accordingly, the object analysis system may be configured to abide by any and all applicable laws with respect to maintaining the privacy of the user and/or content of the engagement data and/or user activity. In some implementations, the object analysis system may not download (or permanently store) any raw private information from the user device, the object analysis system may anonymize and/or encrypt any private information associated with the user and/or the user account. In some implementations, the object analysis system may have or may be configured to have limited access to an account of the user. For example, the object analysis system may be configured to only have access to certain transactions of a transaction account (e.g., transactions that occurred within a most recent threshold time period, transactions that are associated with a particular type of merchant, certain types of transactions, and so on).

Accordingly, as described herein, the user may provide access information associated with authorizing monitoring of the user activity. For example, upon installing the application on the user device (e.g., an application for configuring an association between objects based on an identification of a style associated with the objects), the application may request (e.g., via an authentication token) that the user authorize monitoring of the user activity. Such a request may indicate to the user that the monitoring is for providing an association of objects that may be of interest to the user. With an approval authorizing monitoring the user activity, the application may capture engagement data associated with the user activity. In some implementations, the application may prompt the user to authorize monitoring of individual sessions of the application and/or individual activities that are associated with the engagement data, as described herein. The request and/or prompt may enable the user to opt out from being monitored by the application.

Accordingly, the user activity may be monitored on the user device associated with a user. The user activity may be monitored via the application running on the user device and/or another application, such as an application associated with a browser of the user device (e.g., an applet, an application programming interface, a plug-in, and/or a browser extension). The user activity may be monitored using any suitable techniques, such as scraping hypertext markup language (HTML) associated with the online activity, capturing search strings associated with the online activity, optical scanning of a graphical user interface of the application and/or a display of the user device, among other examples.

As further shown in FIG. 1A, and by reference number 120, the object analysis system receives engagement data. The engagement data may be associated with user activity during a session of the application. The user activity may involve the user accessing (e.g., via the application, a web browser, a social media application, an online shopping application, or the like) one or more images associated with an object type. For example, the one or more images may include thumbnails, icons, and/or images of the objects that are displayed and/or rendered via the application. In some implementations, the engagement data may include the one or more images and/or indicate information associated with the images (e.g., information associated with a source of the one or more images, metadata associated with the one or more images, and/or the like). In some implementations, the engagement data includes and/or is associated with a browsing history of the user activity and/or the session of the application.

Accordingly, based on receiving the engagement data, the object analysis system may monitor user activity of a user. For example, the object analysis system may monitor online activity that is associated with the user browsing webpages using a browser (e.g., on the user device) to research one or more objects associated with a particular style and/or associated with a particular subject. Similarly, the user activity may include social media activity and/or transaction-based activity involving one or more objects that are associated with a particular style may indicate that the user is interested in certain types of objects associated with the one or more objects and/or a certain style associated with the one or more objects. Similarly, in some implementations, other activity can be monitored to determine whether a user is interested in an object and/or a style. Such user activity may include sending a message identifying an object or style accessed during the user activity, accessing offline media associated with an object or style accessed during the user activity, traveling to a location of an object, and/or traveling to a location of an entity associated with the object or style, such as a branch location that sells the object or a location that displays objects associated with the style.

Accordingly, while example implementation 100 may focus on monitoring the user's online activity, some implementations may monitor other types of user activity. For example, the object analysis system may monitor activity associated with a location of the user (e.g., via a location device of the user device), activity associated with the user being involved in a particular event (e.g., a meeting with a potential employer and/or unemployment benefits agency) or being scheduled to be involved in a particular event (e.g., based on a calendar associated with the user), and/or the like. Accordingly, one or more activities may involve a user's action, a user's location, and/or other similar activity or characteristics of the activity.

As further shown in FIG. 1A, and by reference number 130, the object analysis system classifies engagement data according to style. For example, as shown, the object analysis system may classify the engagement data (or subsets of the engagement data) as associated with or indicative of a particular style using a style classification model. More specifically, the style classification model may classify the engagement data as associated with a particular style based on identifying an object accessed during a user activity, as indicated by the engagement data, and determining a style of the object. Additionally, or alternatively, the style classification may determine a type of the object and/or a subject associated with the object (e.g., a particular industry or topic involving the object, such as fashion, home decor, travel, art, architecture). The style classification model may be trained to identify styles based on reference images associated with one or more styles associated with the object type.

In some implementations, the style classification model may include a machine learning model, such as a computer vision model, to identify an object, identify a type of the object, identify a style associated with the object, and/or identify a subject associated with the object. For example, the computer vision model may be trained based on one or more parameters for identifying an image that depicts an object that may be of interest to a user, such as parameters associated with an object type of the object (e.g., a shape, a size, an arrangement, or an association with other objects), parameters associated with a style of the object (e.g., a color, a color palette, a pattern, a design, an aesthetic, and/or an arrangement with other objects associated with the style), and/or parameters associated with a subject of the object (e.g., indicators of a subject and/or objects types associated with a subject). The object analysis system (or other system) may train the style classification model using reference images associated with reference objects that are various object types, that are associated with various styles, and/or that are associated with various subjects. Using the reference images and the one or more parameters as inputs to the style classification model, the object analysis system, via the style classification model, may determine a style of the object to determine whether the user has a particular level of interest in the style (e.g., a level of interest that satisfies a threshold that indicates that the user has a preference for the style over other styles).

The style classification model may utilize any suitable computer vision technique to identify an object within an image and/or determine one or more characteristics of the object (e.g., a type of the object, a subject of the object, and/or a style of the object), as described herein. For example, the computer vision model may include a convolutional neural network and/or a recurrent neural network, and/or other type of image-based machine learning model. The style classification model may be configured to perform one or more of an image recognition technique (e.g., an Inception framework, a ResNet framework, and/or a Visual Geometry Group (VGG) framework), an object detection technique (e.g., a Single Shot Detector (SSD) framework, and/or a You Only Look Once (YOLO) framework), an object in motion technique (e.g., utilizing an optical flow framework of a video), and/or an optical character recognition technique, among other examples.

As shown in FIG. 1A, the user activity may involve the user accessing (e.g., interacting with and/or viewing via a display of the user device) an image of a couch. For example, the user may access the image of the couch during a session of online shopping to determine the price of the couch (shown as “$1000”). In some cases, the user activity may have previously involved access to multiple images of the couch and/or access to images of other couches. Accordingly, the object analysis system and/or style classification model, as described herein, may be configured to determine, by processing the image(s) that the couch or other couches are associated with one or more styles (e.g., classic, antique, modern, rustic, historic, bohemian, farm style, and so on) of home decor (e.g., because a couch, as an object type, is typically associated with home decor).

In this way, the object analysis system, via the style classification model, may determine, based on the engagement data and/or one or more images associated with the engagement data, that an object (e.g., a first object) is a type of object (which may be referred to herein as being associated with an object type) and/or is associated with a style of a subject.

As further shown in FIG. 1A, and by reference number 140, the object analysis system determines the user's style for a subject. The object analysis system may determine the user's preference for a particular style over other styles associated with the subject based on the user activity associated with the engagement data and/or classified styles of objects associated with the engagement data.

The object analysis system may determine, based on the user activity, a level of interest that the user has in the object type. The object analysis system may use a scoring system to determine a score for a style of a subject that is indicative of the user's level of interest in the style. For example, as shown, the object analysis system may track web browser activity, social media activity, transaction information, and/or other types of activity for individual subjects that have been browsed and/or accessed by the user (e.g., during the application session or previous application session). Using such a scoring system, the object analysis system can apply weights (w) to parameters corresponding to the characteristics of the user activity. Such characteristics may include a quantity of the one or more images (e.g., a quantity of one or more images associated with the user activity and/or a particular style identified in the one or more images), a time period of the user activity (e.g., a time period associated with the user accessing the one or more images), a frequency of accessing one or more images of objects associated with a style, a duration of the user activity (e.g., a duration of a session involving the user accessing individual images of the one or more images), and/or a type of the user activity (e.g., whether online browsing, social media interaction, transaction-based activity, and/or the like) that involves the style (or objects associated with the style), among other examples. Accordingly, the object analysis system can determine (e.g., via one or more calculations associated with the scoring system) scores for a set of styles associated with a subject based on the scoring system that are representative of the user's level of interest in the individual styles. For example, the object analysis system can use the following to determine the score (sₒ) based on three characteristics a, b, c of an object i for a style j:

sᵢⱼ=wₐⱼaᵢ+w_{bj}bᵢ+w_{cj}cᵢ+ . . . (1)

where wₐⱼ, w_{bj}, w_{cj} corresponds to adjusted weights based on the relevance to the style j for parameters aᵢ, bᵢ, cᵢ that correspond to the characteristics of the object i. For example, parameters aᵢ, bᵢ , cᵢ may include a value (e.g., a characteristic-specific score) associated with a scale for the respective characteristics associated with parameters aᵢ, bᵢ, cᵢ. Additionally, or alternatively, the adjusted weights W ₐⱼ W _{bj} W _{cj} may be normalized (e.g., where 0≤W ₐⱼ W _{bj} W_{cj}≤1 and Wₐⱼ +w_{bj}+w_{cj}=1).

In some implementations, the scoring system may be associated with a threshold that is used to indicate that the user has a preference for a style over other styles associated with a particular subject. A score value for the threshold may be based on the subject and/or a quantity of different known styles that are associated with the subject. For example, the user may have a level of interest in a style that satisfies a threshold (and, therefore, a preference for the style over other styles of a subject) if a score associated with the level of interest indicates that a relative majority of the user activity (or engagement data) involving the subject is associated with the style (or objects associated with the style).

In some implementations, based on determining a user's level of interest in a style from the engagement data and/or user activity, the object analysis system may store an indication that the user has the level of interest in the style. For example, the object analysis system may store the indication in a profile associated with an account of the user (e.g., a user profile of the user). The object analysis system may utilize the indication to configure an association of objects associated with the style and/or provide the association of the objects to the user.

As shown in FIG. 1B, and by reference number 150, the object analysis system identifies, from user engagement information, that user is interested in an object associated with the style. For example, based on an amount of user activity (e.g., a quantity of interactions involving the object) involving an object, the object analysis system may determine that the user is interested in the object. In some implementations, the object analysis system may use a scoring system (e.g., a weighted average scoring system) to determine the user's level of interest in an object that is similar to the above scoring system for determining the user's level of interest in a style, the object analysis system may determine that the user has a level of interest in an object that satisfies a threshold. In such a case, the object analysis system may infer that the user is likely interested in gaining additional information associated with the object or other objects of the same style (e.g., because the style is the user's preferred style associated with the subject) and/or that the user is likely interested in purchasing the object or other objects that are associated with the same style of the object.

As further shown in FIG. 1B, and by reference number 160, the object analysis system generates an object association according to the style and inventory associated with the style and subject. For example, the object analysis system may identify from inventory information associated with one or more of the object inventory systems one or more objects that are associated with a style of the object (e.g., the preferred style of the user). The individual object inventory systems may be associated with separate entities. The entities may be organizations, merchants, and/or individuals that own objects that are managed by the respective object inventory systems and/or are in the business of selling objects that are managed by the respective object inventory systems).

Accordingly, the object analysis system, based on determining that the user has a threshold level of interest in a first object, the object analysis system may identify a first inventory data structure of a first object inventory system that is associated with the first object and the style. An inventory data structure may be associated with a style based on including a subset of data associated with objects mapped to the style and/or based on an organization of the inventory data structure that sorts objects in subsets of the inventory data structure based on styles of a subject. Based on a style of the first object, the object analysis system may identify a second inventory data structure (or another inventory data structure) of a second object inventory system that is associated with the style and a different entity than the first inventory data structure. The object analysis system may analyze the second inventory data structure to identify one or more objects that are associated with the object. In such a case, the object analysis system may identify a second object in the second inventory data structure.

The second object may be a same object type as the first object, and the object analysis system may identify the second object as an alternative to the first object (e.g., based on being a same type of object, such as another couch in the same style as the couch accessed by the user). For example, the object analysis system may identify the second object as an alternative based on a characteristic of the first object. More specifically, the object analysis system may determine that the price of the first object, such as the couch, may be outside of an acceptable price range of the user (which may be indicated by the user and/or determined from a spending pattern of the user using any suitable techniques, such as analyzing a transaction log of the user account). As another example, the object analysis system may identify the second object as an alternative based on having a different color, a different size, or a different shape than the first object.

In some implementations, the second object may be a different object type than the first object, and the object analysis system may identify the second object as a complement to the first object according to the style of the first object. For example, the second object may be a coffee table that can be arranged with the couch according to the determined style of the couch and coffee table. (e.g., based on the second object being mapped to the style and/or based on the inventory data of the second inventory data structure depicting an image of the object as being associated with the style, as can determined by the style classification model). The first object and the second object may be associated with the style.

In this way, the object analysis system may analyze inventory data based on an object type and/or a style in order to generate an association of objects associated with the style.

The object analysis system may configure an association between a first object (e.g., from a first inventory data structure of a first object inventory system) and a second object (e.g., from a second inventory data structure of a second object inventory system). The object analysis system may configure the association based on a type of the first object and/or a type of the second object. For example, if the type of the first object is the same as the type of the second object, the object analysis system may generate an association to the association that indicates that the second object may be an alternative to a first object. In some implementations, the first object and/or the second object, within the association, can be augmented (e.g., using an augmented reality feature of the application) within an environment or on a display that is depicting a physical environment of the user. In this way, the user can obtain alternative views of the environment by being able to swap between the first object and the second object via the association.

On the other hand, if the type of the first object is different from the type of the second object, the object analysis system may generate an association between the first object and the second object based on a relationship between the first object and the second object. For example, if the first object and the second object complement one another according to a style and/or according to a spatial arrangement of the first object and second object, the object analysis system may configure the association as a layout of the first object and the second object. In such a case, a position of the first object and a position of the second object within the layout are configured according to the relationship between the first object and the second object.

More specifically, if the first object is a couch and the second object is a coffee table (which the object analysis system identified as being a same style as the couch), the layout may include an output image (or augmentable image) that depicts the coffee table on near seats of the couch (e.g., because a typical relationship between a couch and coffee table involves the coffee table being spatially arranged near seats of a couch). As another example with respect to fashion, if a first object is a pair of pants and a second object is a pair of shoes, the layout may include an output image that depicts the shoes aligned with openings at the base of the pair of paints (e.g., in a lookbook format). Accordingly, the layout may include a spatial arrangement of the first object and the second object that enables a user to view the first object and the second object according to a relationship between the first object and the second object and/or according to the style of the first object and the second object.

In some implementations, the configured association may include one or more links (e.g., a uniform resource locator (URL)) associated with the objects. For example, the links may provide access to respective platforms (e.g., transaction platforms, web pages, and/or application platforms) associated with the corresponding object inventory systems of the objects. In some implementations, for an association that involves a layout of the first object and the second object, the object analysis system may configure an association of the first object and the second object that includes a first image-based link that is associated with the first object and a second image-based link that is associated with the second object. For example, the first image-based link may include a first clickable icon depicting the first object and that is associated with a link to the first object inventory system. Further, the second image-based link may include a second clickable icon depicting the second object and that is associated with a link to the second object inventory system.

In this way, the object analysis system may configure an association between objects associated with a same style to permit a user to access the objects and/or access a layout of the objects in association with a style of the objects.

As shown in FIG. 1C, and by reference number 170, the object analysis system provides the object association. For example, the object analysis system may provide the association within a notification to the user device and/or the application.

The object analysis system may provide the association to permit the user to engage in an action involving the first object, the second object, or the association. For example, as shown in FIG. 1C, the user may view the association as a layout of a couch (priced at $500) and a coffee table (priced at $300) via the application and/or the display of the user device. The layout may be augmented within a physical environment of the user. In this way, the association is provided via a user interface of an application that presents, via a user interface, the layout to facilitate an interaction that involves at least one of the first object or the second object. The layout may involve and/or use a first image-based link associated with the couch and a second image-based associated with the coffee table. For example, the first image-based link may facilitate a transaction involving the couch (e.g., by directing the user to a transaction interface, such as a virtual shopping cart, to purchase the couch and/or adding the couch to a transaction interface associated with the application), and/or the second image-based link may facilitate a transaction involving the coffee table.

In this way, via the association, the user may interact with at least one of the first object, the second object, or the association.

As further shown in FIG. 1C, and by reference number 180, the object analysis system receives a response associated with the object bundle. For example, the response may correspond to a user interaction with the association and/or objects of the association. The response may indicate whether the user is further engaging with the objects (e.g., indicating that the user is enjoying the user experience with the objects or is interested in the objects and/or a style of the objects) and/or is not further engaging with the objects (e.g., indicating that the is not enjoying the user experience with the objects and/or is not interested in the objects or a style of the objects). Additionally, or alternatively, the response may indicate that the user is seeking to engage in a transaction (e.g., a purchase) involving one or more of the objects (which may further indicate that the user is interested in the objects and/or a style of the objects).

As further shown in FIG. 1C, and by reference number 190, the object analysis system performs one or more actions based on the response. For example, the object analysis system, via the account management system and/or an object management system associated with an object, may facilitate a transaction between the user and an entity associated with the object inventory system.

In some implementations, based on the response (and/or an indication of whether the user is interested or not interested in one or more of the objects) the object analysis system updates a style preference for the subject. For example, the object analysis system may update a profile of the user to adjust a level of interest in a style according to the response.

In some implementations, based on the response (and/or an indication of whether the user is interested or not interested in one or more of the objects), the object analysis system may retrain the style classification model. In this way, the object analysis system may dynamically train the style classification model in order to continue to learn a preferred style of a user for a particular subject, thereby enabling the object analysis system to identify objects and/or generate associations of objects, as described herein, that are more likely of interest to the user.

In this way, the object analysis system may accurately determine a style of interest to a user and facilitate an association of objects according to the style to permit a user (and/or an application) to quickly and efficiently interact with the objects. Furthermore, the object analysis system may provide increased accuracy with respect to identifying objects that are likely of interest to a user (e.g., by considering style of the objects) and/or associations of objects that are likely to be of interest to a user (e.g., by considering a relationship and style of the objects), relative to other systems that do not perform one or more of the operations described herein.

The style may be specific to a particular subject, which may be identified based on a type of the object. For example, based on identifying a couch, the style classification model may determine a home decor style of the couch (e.g., because a couch is associated with home decor). As another example, based on identifying a shirt, the style classification model may determine a fashion style of the shirt (e.g., because a shirt is associated with fashion).

Certain subsets of the objects may be related to one another according to various characteristics, such as style (e.g., a fashion style, a home decor style, an architectural style, an artistic style, or other types of styles).

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

FIG. 2 is a diagram of an example environment 200 in which systems and/or methods described herein may be implemented. As shown in FIG. 2, environment 200 may include an object analysis system 210, a user device 220, an object inventory system 230, an account management system 240, and a network 250. Devices of environment 200 may interconnect via wired connections, wireless connections, or a combination of wired and wireless connections.

The object analysis system 210 includes one or more devices capable of receiving, generating, storing, processing, providing, and/or routing information associated with configuring an association between objects based on an identification of a style associated with the objects, as described elsewhere herein. The object analysis system 210 may include a communication device and/or a computing device. For example, the object analysis system 210 may include a server, such as an application server, a client server, a web server, a database server, a host server, a proxy server, a virtual server (e.g., executing on computing hardware), or a server in a cloud computing system. In some implementations, the object analysis system 210 includes computing hardware used in a cloud computing environment.

The user device 220 includes one or more devices capable of receiving, generating, storing, processing, and/or providing information associated with user activity and/or a session of an application that is monitored by the object analysis system 210, as described elsewhere herein. The user device 220 may include a communication device and/or a computing device. For example, the user device 220 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The object inventory system 230 includes one or more devices capable of receiving, generating, storing, processing, providing, and/or routing information associated with objects that are associated with one or more styles, as described elsewhere herein. For example, the information may indicate available inventory associated with the objects, links to web pages of entities associated with the objects, information that identifies types of the objects, and/or information that identifies characteristics of the objects that may indicate a relationship to other objects (e.g., a spatial relationship or a spatial arrangement). The object inventory system 230 may include a communication device and/or a computing device. For example, the object inventory system 230 may include a server, such as an application server, a client server, a web server, a database server, a host server, a proxy server, a virtual server (e.g., executing on computing hardware), or a server in a cloud computing system. In some implementations, the object inventory system 230 includes computing hardware used in a cloud computing environment.

The account management system 240 includes one or more devices capable of receiving, generating, storing, processing, providing, and/or routing information associated with managing an account of a user (e.g., an account of a web browser, a social media account, a transaction account, a membership account associated with a merchant, or other type of account), as described elsewhere herein. The account management system 240 may include a communication device and/or a computing device. For example, the account management system 240 may include a server, such as an application server, a client server, a web server, a database server, a host server, a proxy server, a virtual server (e.g., executing on computing hardware), or a server in a cloud computing system. In some implementations, the account management system 240 includes computing hardware used in a cloud computing environment.

The account management system 240 may include and/or be associated with a transaction backend system that is capable of processing, authorizing, and/or facilitating a transaction. For example, the account management system 240 may include or be associated with one or more servers and/or computing hardware of a transaction backend system that is (e.g., in a cloud computing environment or separate from a cloud computing environment) configured to receive and/or store information associated with processing an electronic transaction. The account management system 240, via the transaction backend system, may process a transaction, such as to approve (e.g., permit, authorize, or the like) or decline (e.g., reject, deny, or the like) the transaction and/or to complete the transaction if the transaction is approved. The account management system 240 may process the transaction based on information received from the user device 220, such as transaction data (e.g., information that identifies a transaction amount, a merchant, a time of a transaction, a location of the transaction, or the like), account information communicated to the user device 220 (e.g., account information associated with a transaction card and/or account information associated with a payment application) and/or information stored by the account management system 240 (e.g., for fraud detection).

The account management system 240 (and/or the transaction backend system) may be associated with a financial institution (e.g., a bank, a lender, a credit card company, or a credit union) and/or may be associated with a transaction card association that authorizes a transaction and/or facilitates a transfer of funds. For example, the account management system 240 may be associated with an issuing bank associated with the user account, an acquiring bank (or merchant bank) associated with the merchant and/or the transaction terminal, and/or a transaction card association (e.g., VISA® or MASTERCARD®) associated with a transaction card that is associated with the user account. Based on receiving information associated with the user account from the user device 220, one or more devices of the account management system 240 may communicate to authorize a transaction and/or to transfer funds from an account associated with the transaction device to an account of an entity (e.g., a merchant) associated with the transaction terminal.

The network 250 includes one or more wired and/or wireless networks. For example, the network 250 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 250 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to the object analysis system 210, the user device 220, the object inventory system 230, and/or the account management system 240. In some implementations, the object analysis system 210, the user device 220, the object inventory system 230, and/or the account management system 240 may include one or more devices 300 and/or one or more components of device 300. As shown in FIG. 3, device 300 may include a bus 310, a processor 320, a memory 330, an input component 340, an output component 350, and a communication component 360.

Bus 310 includes one or more components that enable wired and/or wireless communication among the components of device 300. Bus 310 may couple together two or more components of FIG. 3, such as via operative coupling, communicative coupling, electronic coupling, and/or electric coupling. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform one or more operations or processes described elsewhere herein.

Memory 330 includes volatile and/or nonvolatile memory. For example, memory 330 may include random access memory (RAM), read only memory (ROM), a hard disk drive, and/or another type of memory (e.g., a flash memory, a magnetic memory, and/or an optical memory). Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 includes one or more memories that are coupled to one or more processors (e.g., processor 320), such as via bus 310.

Input component 340 enables device 300 to receive input, such as user input and/or sensed input. For example, input component 340 may include a touch screen, a keyboard, a keypad, a mouse, a button, a microphone, a switch, a sensor, a global positioning system sensor, an accelerometer, a gyroscope, and/or an actuator. Output component 350 enables device 300 to provide output, such as via a display, a speaker, and/or a light-emitting diode. Communication component 360 enables device 300 to communicate with other devices via a wired connection and/or a wireless connection. For example, communication component 360 may include a receiver, a transmitter, a transceiver, a modem, a network interface card, and/or an antenna.

Device 300 may perform one or more operations or processes described herein. For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

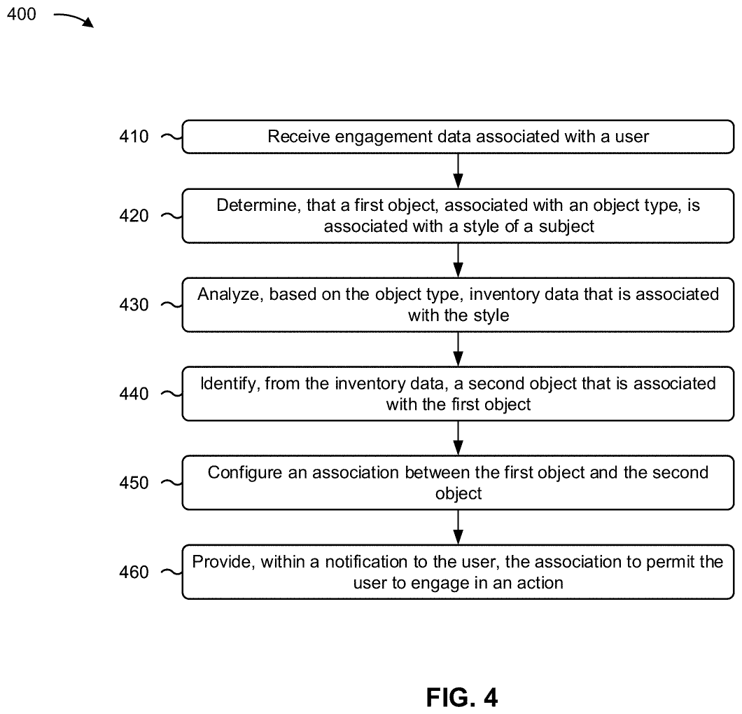

FIG. 4 is a flowchart of an example process 400 associated with configuring an association between objects based on an identification of a style associated with the objects. In some implementations, one or more process blocks of FIG. 4 may be performed by an object analysis system (e.g., object analysis system 210). In some implementations, one or more process blocks of FIG. 4 may be performed by another device or a group of devices separate from or including the object analysis system, such as the user device 220, the object inventory system 230, and/or the account management system 240. Additionally, or alternatively, one or more process blocks of FIG. 4 may be performed by one or more components of device 300, such as processor 320, memory 330, input component 340, output component 350, and/or communication component 360.

As shown in FIG. 4, process 400 may include receiving engagement data associated with a user (block 410). The engagement data is associated with user activity involving the user accessing one or more images associated with an object type.

As further shown in FIG. 4, process 400 may include determining that a first object, associated with the object type, is associated with a style of a subject (block 420). The style classification model may be trained to identify styles of the subject based on reference images associated with one or more of the styles of the subject. The object analysis system may determine that the first object is associated with the style based on the one or more images and using a style classification model.

As further shown in FIG. 4, process 400 may include analyzing, based on the object type, inventory data that is associated with the style (block 430). As further shown in FIG. 4, process 400 may include identifying, from the inventory data, a second object that is associated with the first object (block 440).

As further shown in FIG. 4, process 400 may include configuring an association between the first object and the second object (block 450). As further shown in FIG. 4, process 400 may include providing, within a notification to the user, the association to permit the user to engage in an action involving the first object, the second object, or the association (block 460).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for configuring an association between objects, the system comprising:
one or more memories; and
one or more processors, communicatively coupled to the one or more memories, configured to:
receive engagement data associated with a user,
wherein the engagement data is associated with user activity involving the user accessing one or more images associated with an object type;
determine, based on the one or more images and using a style classification model, that a first object, associated with the object type, is associated with a style of a subject,
wherein the style classification model is trained to identify styles of the subject based on reference images associated with one or more of the styles of the subject;
analyze, based on the object type, inventory data that is associated with the style;
identify, from the inventory data, a second object that is associated with the first object;
configure the association between the first object and the second object; and
provide, within a notification to the user, the association to permit the user to engage in an action involving the first object, the second object, or the association.

2. The system of claim 1, wherein the one or more processors, prior to receiving the engagement data, are configured to:
request the user to authorize monitoring of the user activity;
receive a user input that authorizes the monitoring of the user activity; and
capture, based on receiving the user input, the engagement data from the user activity.

3. The system of claim 1, wherein a type of the first object and a type of the second object are both the object type.

4. The system of claim 1, wherein the inventory data is analyzed based on determining that the user has a level of interest in the style that satisfies a threshold,
wherein the level of interest is determined using a scoring system that is associated with the threshold and one or more parameters of the engagement data.

5. The system of claim 4, wherein the one or more parameters comprise at least one of:
a quantity of the one or more images,
a time period associated with the user accessing the one or more images,
a frequency of accessing the one or more images within the time period,
a duration of a session involving the user accessing individual images of the one or more images, or
a type of the user activity that involves the style.

6. The system of claim 4, wherein the one or more processors are further configured to:
store, in a profile associated with an account of the user, an indication that the user has the level of interest in the style,
wherein the notification is provided to a user device that is associated with the account.

7. The system of claim 1, wherein the style classification model comprises a computer vision model that includes at least one of:
a convolutional neural network that is trained based on the reference images, or
a recurrent neural network that is trained based on the reference images.

8. The system of claim 1, wherein, prior to analyzing the inventory data, the one or more processors are configured to:
identify a first subset of the inventory data in a first inventory data structure that is associated with the subject,
wherein the first inventory data structure is associated with a first entity that is associated with the first object; and
identify a second subset of the inventory data stored in a second inventory data structure that is associated with the subject,
wherein the second inventory data structure is associated with a second entity that is associated with the second object.

9. A non-transitory computer-readable medium storing a set of instructions, the set of instructions comprising:
one or more instructions that, when executed by one or more processors of a system, cause the system to:
receive one or more images associated with user activity involving an object type;
determine, based on the user activity, a level of interest that the user has in the object type;
determine, using a style classification model and based on determining that the level of interest that satisfies a threshold, that a first object, associated with the object type, is associated with a style,
wherein the style classification model is trained to identify styles based on reference images associated with one or more styles associated with the object type;
identify, from inventory data in an inventory data structure associated with the style, a second object that is related to the first object;
configure, based on a relationship between the first object and the second object, a layout of the first object and the second object; and
provide, via a user interface, the layout to facilitate an interaction that involves at least one of the first object or the second object.

10. The non-transitory computer-readable medium of claim 9, wherein a type of the first object is the object type and a type of the second object is a type that is different from the object type.

11. The non-transitory computer-readable medium of claim 9, wherein the level of interest is determined using a scoring system that is associated with the threshold and one or more parameters associated with the user activity.

12. The non-transitory computer-readable medium of claim 11, wherein the one or more parameters comprise at least one of:
a quantity of the one or more images associated with the user activity, a time period of the user activity,
a frequency of accessing the one or more images within the time period,
a duration of the user activity, or
a type of the user activity that involves the style.

13. The non-transitory computer-readable medium of claim 9, wherein the inventory data structure identifies the second object, and
wherein the inventory data structure is separate from another inventory data structure that is associated with the style and that identifies the first object.

14. The non-transitory computer-readable medium of claim 9, wherein the layout is a spatial arrangement of a first image-based link that is associated with the first object and a second image-based link that is associated with the second object,
wherein a position of the first object and a position of the second object within the layout are configured according to the relationship between the first object and the second object.

15. A method associated with configuring an association between objects, comprising:
receiving, by a device, engagement data associated with a user,
wherein the engagement data is associated with user activity involving the user accessing one or more images associated with a style;
determining, by the device and using a style classification model, that the engagement data is associated with the style,
wherein the style classification model is trained to identify styles of a subject based on reference images associated with one or more of the styles of the subject;
determining, by the device and based on the engagement data, a level of interest that the user has in one or more objects associated the style;
identifying, by the device and based on the level of interest satisfying a threshold, a first object and a second object that are associated with the style;
configuring, by the device, the association between the first object and the second object; and
providing, by the device, the association to permit the user to interact with at least one of the first object, the second object, or the association.

16. The method of claim 15, wherein the user activity comprises at least one of:
an online activity,
a social media activity, or
a transaction-based activity.

17. The method of claim 15, wherein the style classification model comprises a computer vision model that is trained based on the reference images.

18. The method of claim 15, wherein the first object is identified in a first inventory data structure and the second object is identified in a second inventory data structure,
wherein the first inventory data structure is associated with a first entity and the second inventory data structure is associated with a second entity that is separate from the first entity.

19. The method of claim 18, wherein the association is provided via a user interface of an application that presents, using a first image-based link to the first inventory data structure and a second image-based link to the second inventory data structure, a layout of the first object and the second object according to the association.

20. The method of claim 15, wherein configuring the association between the first object and the second object comprises:
determining a spatial relationship between an arrangement of the first object and an arrangement of the second object; and
configuring the association within an output image according to the spatial relationship.
